(19) United States
(12) Patent Application Publication
(10) Pub. No.: US 2011/0292090 A1
(43) Pub. Date: Dec. 1, 2011

(54) DISPLAY APPARATUS

(75) Inventor: Kazuhiro Otani, Osaka (JP)

(73) Assignee: SANYO ELECTRIC CO., LTD., Osaka (JP)

(21) Appl. No.: 13/114,562

(22) Filed: May 24, 2011

(30) Foreign Application Priority Data
May 25, 2010 (JP) 2010-119660

(51) Int. Cl. G09G 3/36; G09G 5/10

(52) U.S. Cl. 345/690; 345/102

(57) ABSTRACT

A display apparatus includes: a display panel; a backlight portion that shines light onto the display panel from a rear surface of the display panel; a backlight control portion that controls the backlight portion. The backlight portion is an LED backlight unit that includes a plurality of LEDs that are divided into a plurality of fixed groups. The backlight control portion is capable of performing at least either of: first control which turns off the LEDs that belong to one group and turns on the LEDs that belong to a group other than the one group and second control which turns on the LEDs that belong to the one group at a brightness lower than a brightness for turning on the LEDs that belong to the group other than the one group.

This nonprovisional application claims priority under 35 U.S.C. §119(a) on Patent Application No. 2010-119660 filed in Japan on May 25, 2010, the contents of which are hereby incorporated by reference.

### BACKGROUND OF THE INVENTION

1. Field of the Invention

The present invention relates to a display apparatus, more particularly, to a display apparatus that includes an LED backlight unit.

2. Description of the Related Art

In a display apparatus (e.g., a transmissive liquid crystal display apparatus) that includes a display panel and a backlight unit that shines light onto the display panel from a rear surface of the display panel, in a case where the display apparatus has a relatively large-size screen like a T.V. receiver, a structure is general, in which fluorescent lamps such as a CCFL (Cold Cathode Fluorescent Lamp), an EEFL (External Electrode Fluorescent Lamp) and the like are used as the backlight.

However, in recent years, from the viewpoint of an environmental problem and the like, a display apparatus that uses an LED (Light Emitting Diode) having power consumption smaller than the fluorescent lamp for a light source of the backlight unit, that is, a display apparatus that has an LED backlight unit is attracting attention.

The display apparatus that has the LED backlight unit is already produced and put on the market; however, the life (about 30,000 hours) of the LED itself is short, that is, about half of the fluorescent lamp, so that the display apparatus has a problem that the product life is short.

Here, as a liquid crystal display apparatus that is able to achieve a long life of the LED backlight unit, there is a liquid crystal display apparatus that includes: a liquid crystal panel that is divided into a plurality of sub-display regions; an LED backlight unit that includes a plurality of light sources that corresponding to each of the sub-display regions and each of the light sources includes a plurality of LEDs; a calculation portion that for each of the light sources, calculates a brightness, which the light source needs, from an image signal of a pixel in the sub-display region that corresponds to the light source; a determination portion that for each of the light sources, determines a minimum number of LEDs necessary to obtain the calculated brightness and selects in a predetermined order the LEDs for the determined number from the plurality of LEDs; and a light emission control portion that makes only the selected LEDs emit light.

However, in this liquid crystal display apparatus, to achieve the light emission of the LEDs only selected by the determination portion, there is a problem that a structure of the LED backlight unit and a structure of the light emission control portion become complicated.

### SUMMARY OF THE INVENTION

According to an aspect of the present invention, a display apparatus includes: a display panel; a backlight portion that shines light onto the display panel from a rear surface of the display panel; a backlight control portion that controls the backlight portion. The backlight portion is an LED backlight unit that includes a plurality of LEDs that are divided into a plurality of fixed groups. The backlight control portion is capable of performing at least either of: first control which turns off the LEDs that belong to one group and turns on the LEDs that belong to a group other than the one group and second control which turns on the LEDs that belong to the one group at a brightness lower than a brightness for turning on the LEDs that belong to the group other than the one group.

Besides, according to another aspect of the present invention, a display apparatus includes: a display panel; a backlight portion that shines light onto the display panel from a rear surface of the display panel; a backlight control portion that controls the backlight portion; and a temperature sensor that detects an ambient temperature of the backlight portion. The backlight portion is an LED backlight unit that includes a plurality of LEDs. The backlight control portion, if the ambient temperature of the backlight portion detected by the temperature sensor exceeds a predetermined temperature, turns on all of the plurality of LEDs at a brightness lower than a brightness at a time the ambient temperature of the backlight portion detected by the temperature sensor is equal to or lower than the predetermined temperature.

The meanings and effects of the present invention will be more apparent from the following description of embodiments. However, the following embodiments are merely embodiments of the present invention: the present invention and the meanings of the terms for respective constituent elements are not limited to those described in the following embodiments.

### BRIEF DESCRIPTION OF THE DRAWINGS

FIG. 1 is a diagram showing a schematic structure of a display apparatus according to a first embodiment of the present invention.

FIG. 2 is a diagram showing a structure of an LED backlight portion that is used in the display apparatus according to the first embodiment of the present invention.

FIG. 3 is a diagram showing a structural example of an LED backlight portion that is able to replace the LED backlight portion shown in FIG. 2.

FIG. 4A is a diagram showing another structural example of an LED backlight portion that is able to replace the LED backlight portion shown in FIG. 2.

FIG. 4B is a diagram showing still another structural example of an LED backlight portion that is able to replace the LED backlight portion shown in FIG. 2.

FIG. 5 is a diagram showing a schematic structure of a display apparatus according to a second embodiment of the present invention.

FIG. 6 is a diagram showing a structure of an LED backlight portion that is used in the display apparatus according to the second embodiment of the present invention.

FIG. 7 is a diagram showing a structural example of an LED backlight portion that is able to replace the LED backlight portion shown in FIG. 6.

FIG. 8 is a diagram showing another structural example of an LED backlight portion that is able to replace the LED backlight portion shown in FIG. 6.

FIG. 9 is a diagram showing a schematic structure of a display apparatus according to a third embodiment of the present invention.

FIG. 10 is a diagram showing a schematic structure of a display apparatus according to a fourth embodiment of the present invention.

FIG. 11 is a diagram showing a structure of an LED backlight portion that is used in the display apparatus according to the fourth embodiment of the present invention.

FIG. 12 is a diagram showing a schematic structure of a display apparatus according to a fifth embodiment of the present invention.

FIG. 13 is a diagram showing a schematic structure of a display apparatus according to a sixth embodiment of the present invention.

FIG. 14 is a diagram showing a schematic structure of a display apparatus according to a seventh embodiment of the present invention.

### DETAILED DESCRIPTION OF PREFERRED EMBODIMENTS

Embodiments of the present invention are described hereinafter with reference to the drawings.

### First Embodiment

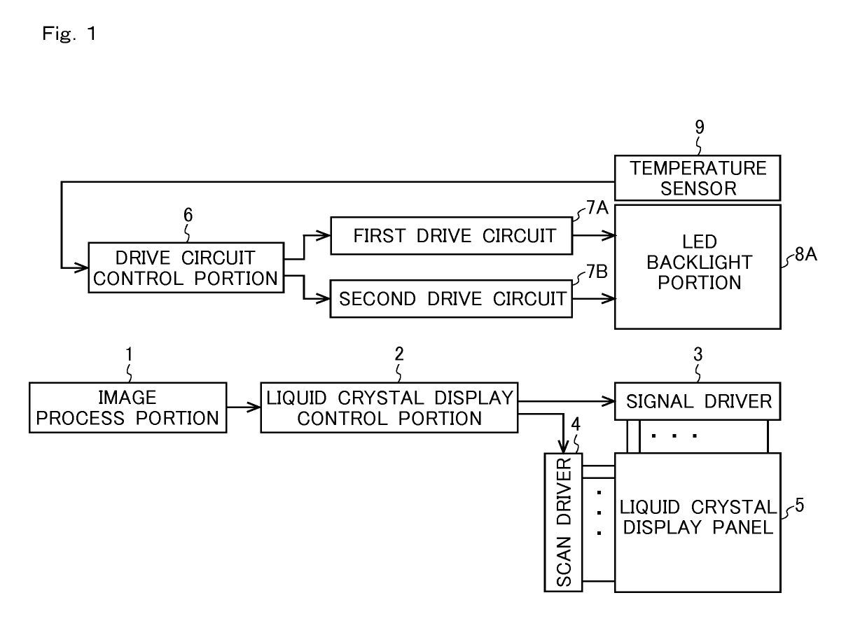

FIG. 1 shows a schematic structure of a display apparatus according to a first embodiment of the present invention. The display apparatus shown in FIG. 1 according to the first embodiment of the present invention is a liquid crystal display apparatus that includes: an image process portion 1; a liquid crystal display control portion 2; a signal driver 3; a scan driver 4; a liquid crystal display panel 5; a drive circuit control portion 6; a first drive circuit 7A; a second drive circuit 7B; an LED backlight portion 8A; and a temperature sensor 9. Here, in the present embodiment, the drive circuit control portion 6, the first drive circuit 7A, and the second drive circuit 7B correspond to a backlight control portion described in claims.

The image process portion 1 applies various processes to: an image signal (e.g., an image signal that is generated by a not-shown tuner portion) that is generated in the inside of the liquid crystal display apparatus, and an image signal that is input from outside of the liquid crystal display apparatus; thereafter, outputs the image signal to the liquid crystal display control portion 2. The liquid crystal display control portion 2, in accordance with the image signal output from the image process portion 1, controls the signal driver 3 and the scan driver 4. The signal driver 3, in accordance with the control by the liquid crystal control portion 2, supplies data to a signal line (not shown) of the liquid crystal display panel 5; the scan driver 4, in accordance with the control by the liquid crystal control portion 2, supplies data to a scan line (not shown) of the liquid crystal display panel 5. In this way, the liquid crystal display panel 5 operates.

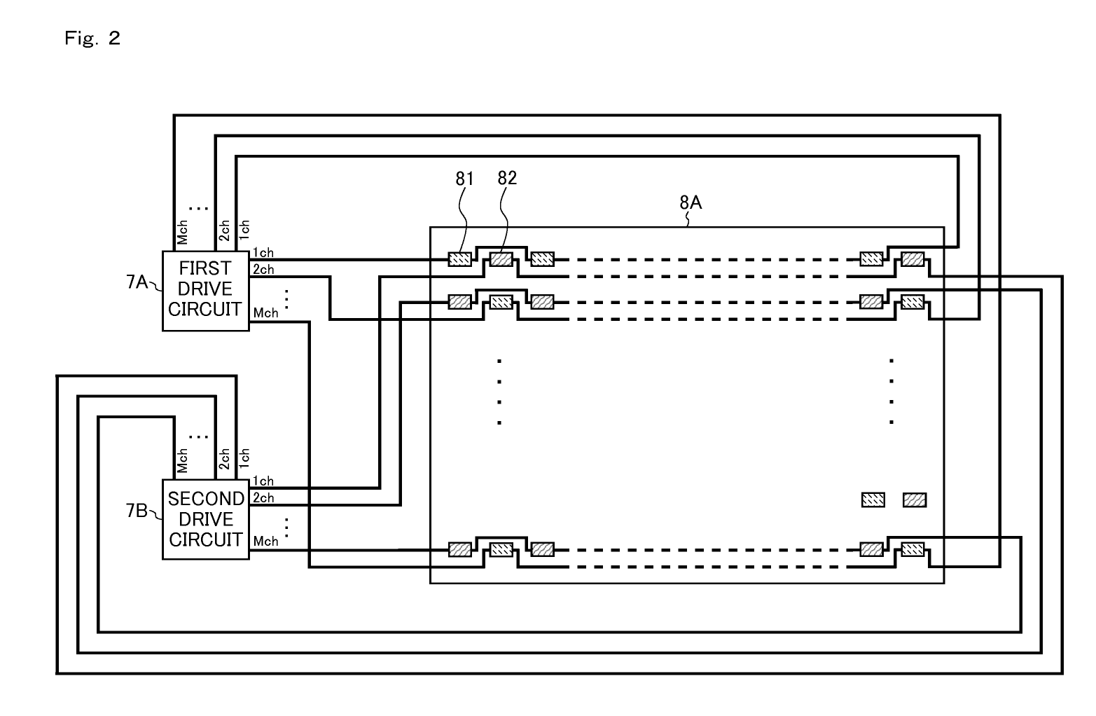

The LED backlight portion 8A is a direct type of backlight unit that includes: a plurality of white LEDs 81 that belong to a first group; and a plurality of white LEDs 82 that belong to a second group. In the LED backlight portion 8A, as shown in FIG. 2, the white LED 81 belonging to the first group and the white LED 82 belonging to the second group are periodically disposed such that the white LED 81 belonging to the first group is disposed every two devices and the white LED 82 as well belonging to the second group is disposed every two devices. In the LED backlight portion 8A, the plurality of white LEDs are divided into the fixed groups (first group and second group), so that a structure of the LED backlight portion 8A does not become complicated. The first drive circuit 7A is an M-channel output drive circuit and is able to perform constant-current driving in which an independent constant current value is set for every channel. To each channel of the first drive circuit 7A, N white LEDs 81 belonging to the first group are connected. Besides, the second drive circuit 7B is an M-channel output drive circuit and is able to perform constant-current driving in which an independent constant current value is set for every channel. To each channel of the second drive circuit 7B, N white LEDs 82 belonging to the second group are connected. Here, in FIG. 2, part of the wirings that connect the LEDs in the same group to each other are not shown.

The temperature sensor 9 detects an ambient temperature of the LED backlight portion 8A and outputs the detection result to the drive circuit control portion 6. The drive circuit control portion 6, in accordance with the ambient temperature of the LED backlight portion 8A detected by the temperature sensor 9, controls the first drive circuit 7A and the second drive circuit 7B. Specific control is as follows.

The drive circuit control portion 6 determines whether the ambient temperature of the LED backlight portion 8A detected by the temperature sensor 9 is equal to or over a predetermined temperature.

If the ambient temperature of the LED backlight portion 8A detected by the temperature sensor 9 is not equal to nor over the predetermined temperature, the drive circuit control portion 6 operates both of the first drive circuit 7A and the second drive circuit 7B. In this way, both of the white LED 81 belonging to the first group and the white LED 82 belonging to the second group are turned on.

On the other hand, if the ambient temperature of the LED backlight portion 8A detected by the temperature sensor 9 is equal to or over the predetermined temperature, the drive circuit control portion 6 operates only either of the first drive circuit 7A and the second drive circuit 7B. In this way, only either of the white LED 81 belonging to the first group and the white LED 82 belonging to the second group is turned on. Here, a structure (e.g., a structure in which the group to be turned on is changed for each period when the ambient temperature of the LED backlight portion 8A is equal to or over the predetermined temperature) is desirable, in which it is possible to avoid an excessive difference between a life expiration time of the white LED 81 belonging to the first group and a life expiration time of the white LED 82 belonging to the second group.

According to the above control, when the ambient temperature of the LED backlight portion 8A is equal to or over the predetermined temperature, it is possible to decrease the number of turned-on LEDs and to reduce a heat generation amount from the LED backlight portion 8A. The LED has a characteristic that if the LED operates at a higher temperature, the life becomes shorter, so that according to the above control, it is possible to achieve a long life of the LED backlight portion 8A.

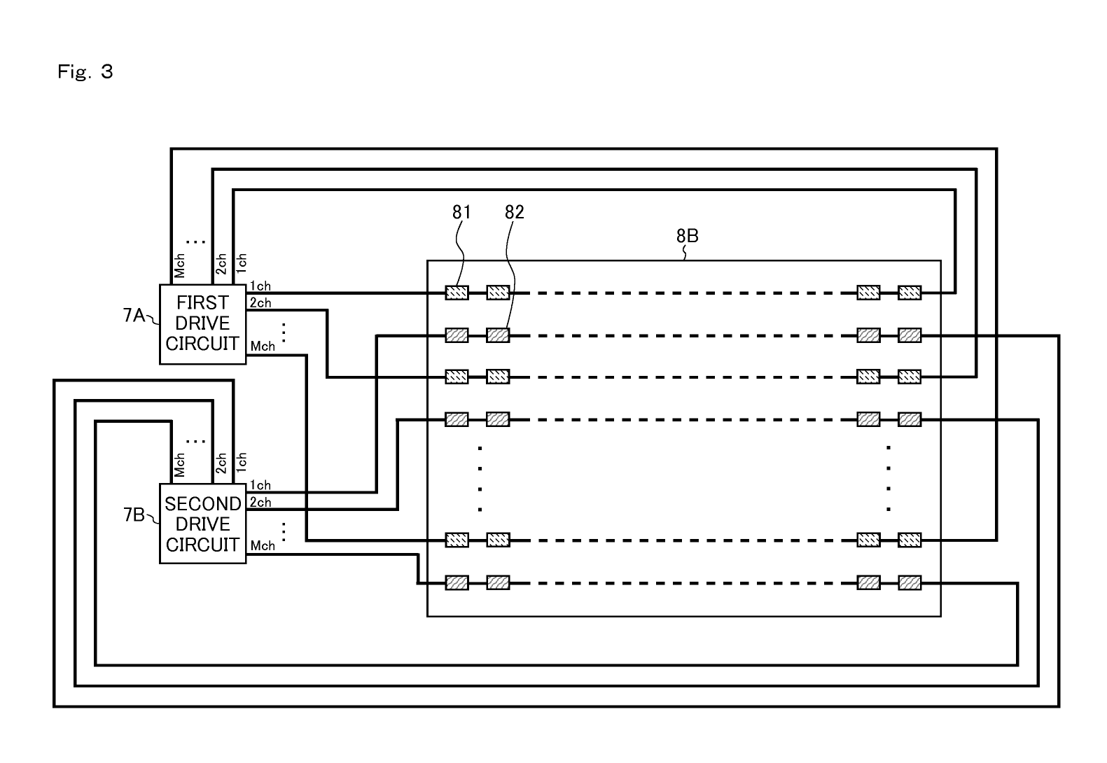

Here, the LED backlight portion 8A may be replaced with an LED backlight portion 8B that is a direct type of backlight unit. In the LED backlight portion 8B, as shown in FIG. 3, the white LED 81 belonging to the first group and the white LED 82 belonging to the second group are periodically disposed such that the white LED 81 belonging to the first group is disposed every two lines and the white LED 82 as well belonging to the second group is disposed every two lines. Here, in FIG. 3, part of the wirings that connect the LEDs in the same group to each other are not shown. In the LED backlight portion 8B as well, like the LED backlight portion 8A, the plurality of white LEDs are divided into the fixed groups (first group and second group), so that a structure of the LED backlight portion 8B does not become complicated.

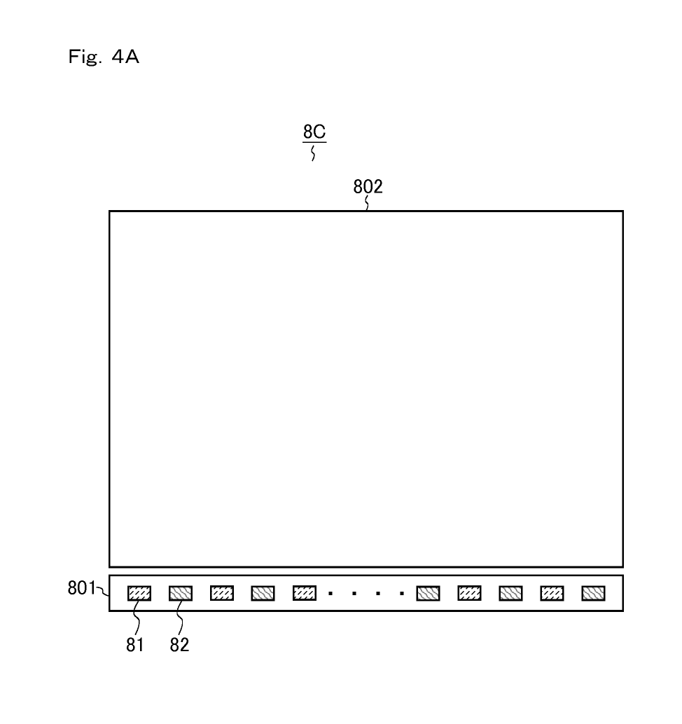

Besides, the LED backlight portion 8A may be replaced with an LED backlight portion 8C that is an edge type of backlight unit. In the LED backlight portion 8C, as shown in FIG. 4A, a light source portion 801 and a light guide plate 802 are disposed; the white LED 81 belonging to the first group and the white LED 82 belonging to the second group are periodically disposed in the light source portion 801 such that the white LED 81 belonging to the first group is disposed every two devices in the light source portion 801 and the white LED 82 as well belonging to the second group is disposed every two devices in the light source portion 801. Besides, the LED backlight portion 8C has one unit of the light source portion 801; however, a structure may be employed, which includes a plurality of units of the light source portion 801. Such a structural example (an example which has four units) is shown in FIG. 4B. Here, in FIG. 4A and FIG. 4B, part of the wirings that connect the LEDs in the same group to each other are not shown. In the LED backlight portion 8C and the backlight portion as well shown in FIG. 4B, like the LED backlight portions 8A and 8B, the plurality of white LEDs are divided into the fixed groups (first group and second group), so that structures of the LED backlight portion 8C and the LED backlight portion shown in FIG. 4B do not become complicated.

### Second Embodiment

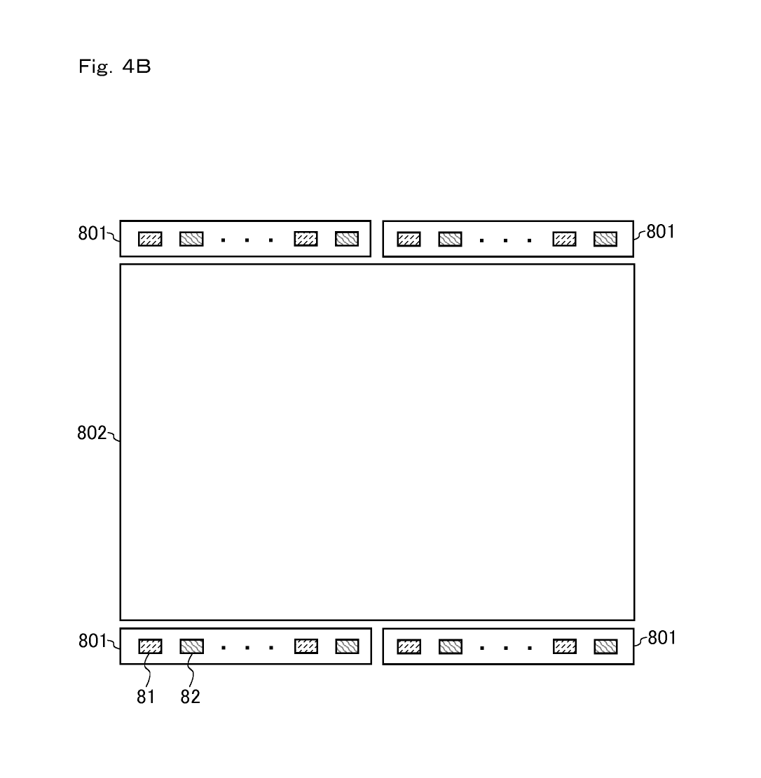

FIG. 5 shows a schematic structure of a display apparatus according to a second embodiment of the present invention. Here, in FIG. 5, the same portions as FIG. 1 are indicated by the same reference numbers and detailed description is slipped. The display apparatus shown in FIG. 5 according to the second embodiment of the present invention is a liquid crystal display apparatus that includes: the image process portion 1; the liquid crystal display control portion 2; the signal driver 3; the scan driver 4; the liquid crystal display panel 5; the drive circuit control portion 6; the first drive circuit 7A; the second drive circuit 7B; a third drive circuit 7C; an LED backlight portion 8D; and the temperature sensor 9. Here, in the present embodiment, the drive circuit control portion 6, the first drive circuit 7A, the second drive circuit 7B, and the third drive circuit 7C correspond to the backlight control portion described in claims.

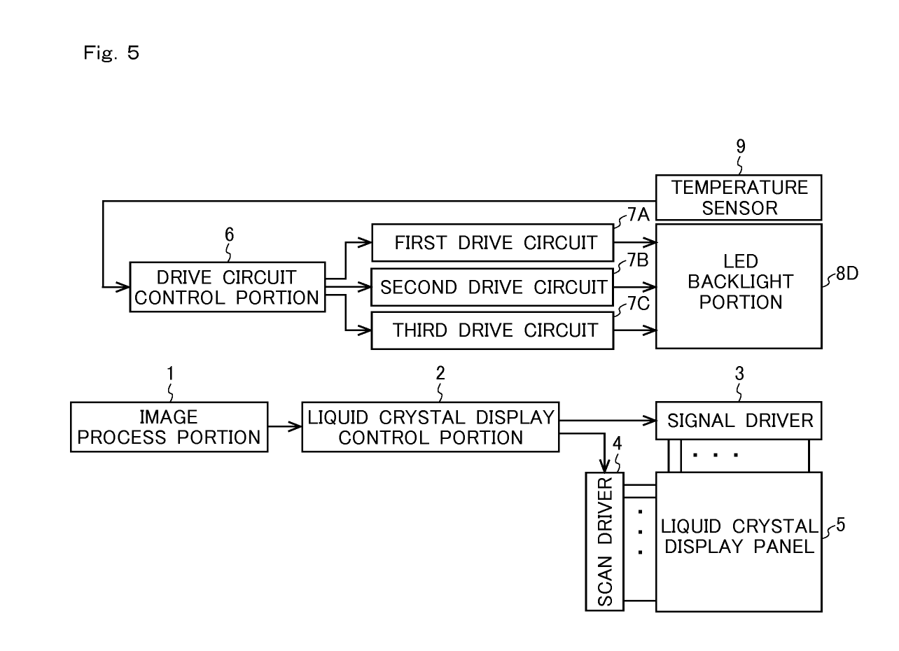

The LED backlight portion 8D is a direct type of backlight unit that includes: a plurality of white LEDs 81 that belong to the first group; a plurality of white LEDs 82 that belong to the second group; and a plurality of white LEDs 83 that belong to a third group. In the LED backlight portion 8D, as shown in FIG. 6, the white LED 81 belonging to the first group, the white LED 82 belonging to the second group and the white LED 83 belonging to the third group are periodically disposed such that the white LED 81 belonging to the first group is disposed every three devices, the white LED 82 as well belonging to the second group is disposed every three devices, and the white LED 83 as well belonging to the third group is disposed every three devices. Here, in FIG. 6, part of the wirings that connect the LEDs in the same group to each other are not shown. In the LED backlight portion 8D, the plurality of white LEDs are divided into the fixed groups (first group, second group and third group), so that a structure of the LED backlight portion 8D does not become complicated.

The first drive circuit 7A is an M-channel output drive circuit and is able to perform constant-current driving in which an independent constant current value is set for every channel. To each channel of the first drive circuit 7A, N white LEDs 81 belonging to the first group are connected. Besides, the second drive circuit 7B is an M-channel output drive circuit and is able to perform constant-current driving in which an independent constant current value is set for every channel. To each channel of the second drive circuit 7B, N white LEDs 82 belonging to the second group are connected. Besides, the third drive circuit 7C is an M-channel output drive circuit and is able to perform constant-current driving in which an independent constant current value is set for every channel. To each channel of the third drive circuit 7C, N white LEDs 83 belonging to the third group are connected.

In the present embodiment, the temperature sensor 9 detects an ambient temperature of the LED backlight portion 8D and outputs the detection result to the drive circuit control portion 6. In the present embodiment, the drive circuit control portion 6, in accordance with the ambient temperature of the LED backlight portion 8D detected by the temperature sensor 9, controls the first drive circuit 7A, the second drive circuit 7B and the third drive circuit 7C. Specific control is as follows.

The drive circuit control portion 6 determines whether the ambient temperature of the LED backlight portion 8D detected by the temperature sensor 9 is equal to or over a predetermined temperature.

If the ambient temperature of the LED backlight portion 8D detected by the temperature sensor 9 is not equal to nor over the predetermined temperature, the drive circuit control portion 6 operates all of the first drive circuit 7A, the second drive circuit 7B and the third drive circuit 7C. In this way, all of the white LED 81 belonging to the first group, the white LED 82 belonging to the second group and the white LED 83 belonging to the third group are turned on.

On the other hand, if the ambient temperature of the LED backlight portion 8D detected by the temperature sensor 9 is equal to or over the predetermined temperature, the drive circuit control portion 6 operates only one of the first drive circuit 7A, the second drive circuit 7B and the third drive circuit 7C. In this way, only one of the white LED 81 belonging to the first group, the white LED 82 belonging to the second group and the white LED 83 belonging to the third group is turned on. Here, a structure (e.g., a structure in which the group to be turned on is changed for each period when the ambient temperature of the LED backlight portion 8D is equal to or over the predetermined temperature) is desirable, in which it is possible to avoid an excessive difference among a life expiration time of the white LED 81 belonging to the first group, a life expiration time of the white LED 82 belonging to the second group and a life expiration time of the white LED 83 belonging to the third group.

According to the above control, when the ambient temperature of the LED backlight portion 8D is equal to or over the predetermined temperature, it is possible to decrease the number of turn-on LEDs and to reduce a heat generation amount from the LED backlight portion 8D. The LED has a characteristic that if the LED operates at a higher temperature, the life becomes shorter, so that according to the above control, it is possible to achieve a long life of the LED backlight portion 8D.

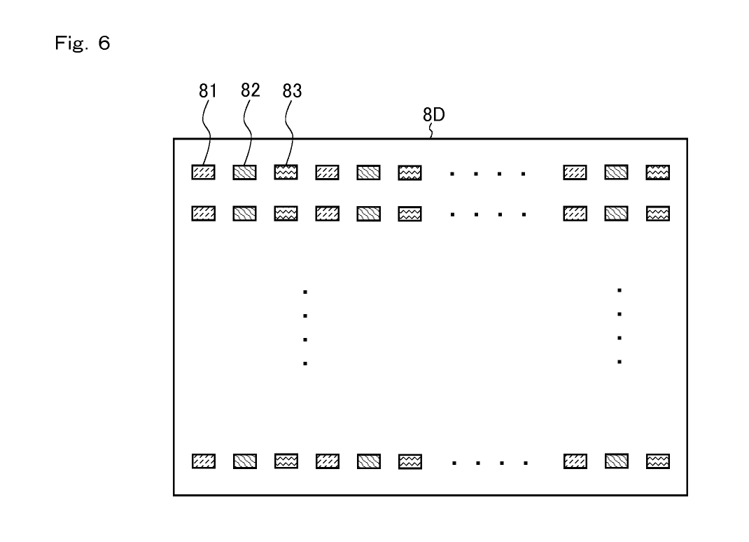

Here, the LED backlight portion 8D may be replaced with an LED backlight portion 8E that is a direct type of backlight unit. In the LED backlight portion 8E, as shown in FIG. 7, the white LED 81 belonging to the first group, the white LED 82 belonging to the second group and the white LED 83 belonging to the third group are periodically disposed such that the white LED 81 belonging to the first group is disposed every three lines, the white LED 82 as well belonging to the second group is disposed every three lines, and the white LED 83 as well belonging to the third group is disposed every three lines. Here, in FIG. 7, part of the wirings that connect the LEDs in the same group to each other are not shown. In the LED backlight portion 8E as well, like the LED backlight portion 8D, the plurality of white LEDs are divided into the fixed groups (first group, second group and third group), so that a structure of the LED backlight portion 8E does not become complicated.

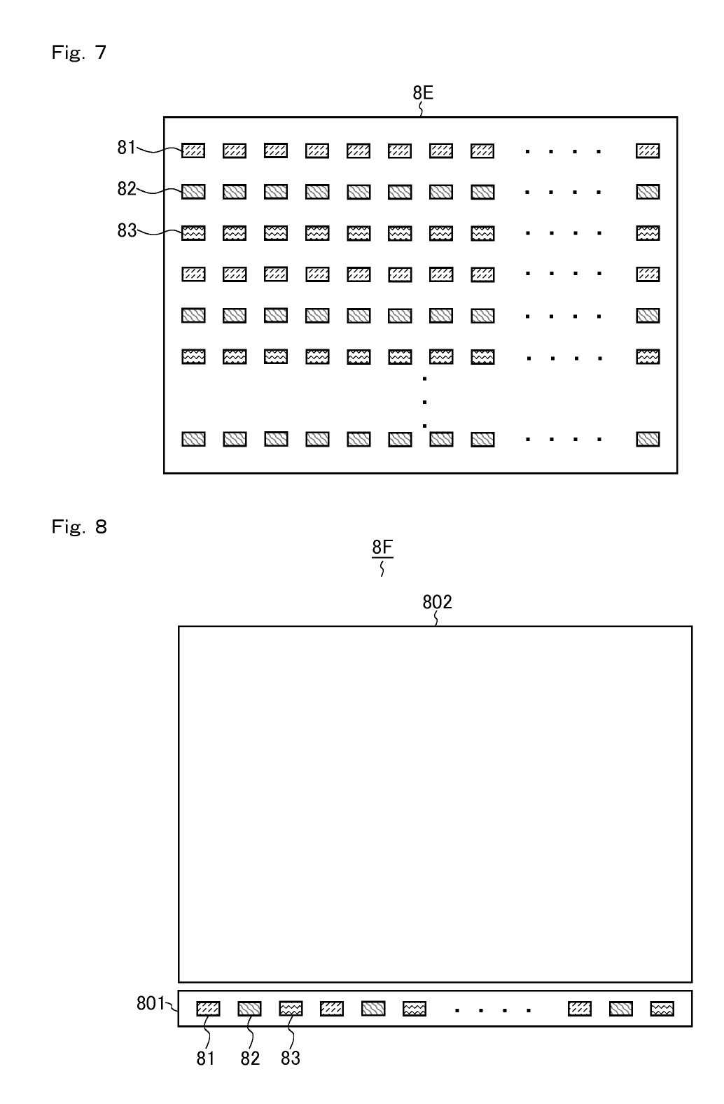

Besides, the LED backlight portion 8D may be replaced with an LED backlight portion 8F that is an edge type of backlight unit. In the LED backlight portion 8F, as shown in FIG. 8, the light source portion 801 and the light guide plate 802 are disposed; the white LED 81 belonging to the first group, the white LED 82 belonging to the second group and the white LED 83 belonging to the third group are periodically disposed in the light source portion 801 such that the white LED 81 belonging to the first group is disposed every three devices in the light source portion 801, the white LED 82 as well belonging to the second group is disposed every three devices in the light source portion 801 and the white LED 83 belonging to the third group is disposed every three devices in the light source portion 801. Besides, the LED backlight portion 8F has one unit of the light source portion 801; however, a structure may be employed, which includes a plurality of units of the light source portion 801. Here, in FIG. 8, part of the wirings that connect the LEDs in the same group to each other are not shown. In the LED backlight portion 8F and a backlight portion as well in which the light source portion 801 of the LED backlight portion 8F is divided into a plurality of units, like the LED backlight portions 8D and 8E, the plurality of white LEDs are divided into the fixed groups (first group, second group and third group), so that structures of the LED backlight portion 8F and the LED backlight portion in which the light source portion 801 of the LED backlight portion 8F is divided into the plurality of units do not become complicated.

### Third Embodiment

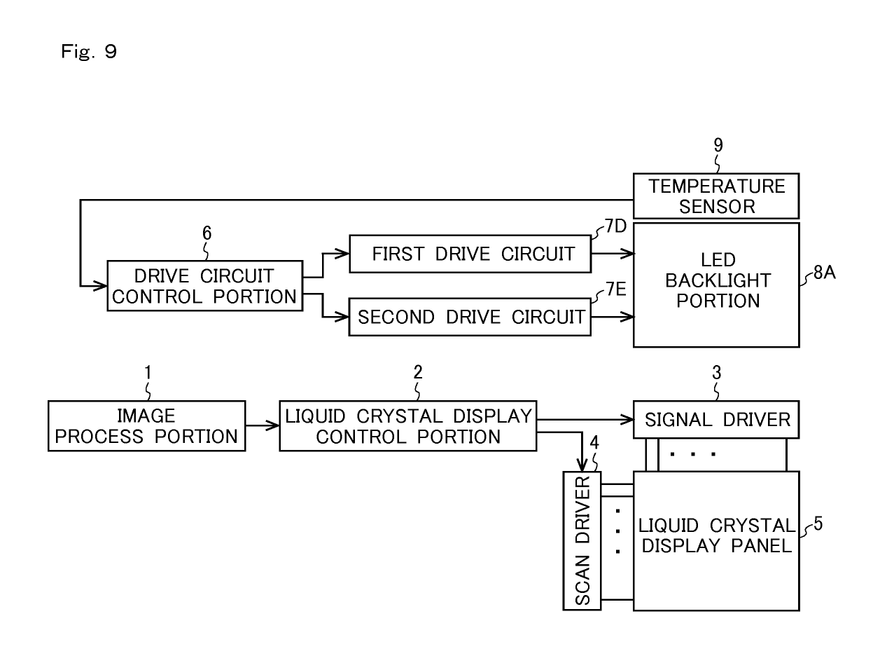

FIG. 9 shows a schematic structure of a display apparatus according to a third embodiment of the present invention. Here, in FIG. 9, the same portions as FIG. 1 are indicated by the same reference numbers and detailed description is slipped. The display apparatus shown in FIG. 9 according to the third embodiment of the present invention has a structure in which the first drive circuit 7A and the second drive circuit 7B are removed from the display apparatus shown in FIG. 1 according to the first embodiment of the present invention; instead of them, a first drive circuit 7D and a second drive circuit 7E are disposed. Here, in the present embodiment, the drive circuit control portion 6, the first drive circuit 7D, and the second drive circuit 7E correspond to the backlight control portion described in claims.

The first drive circuit 7D is an M-channel output drive circuit and is able to perform constant-current driving in which an independent constant current value is set for every channel. To each channel of the first drive circuit 7D, N white LEDs 81 belonging to the first group are connected. Besides, the second drive circuit 7E is an M-channel output drive circuit and is able to perform constant-current driving in which an independent constant current value is set for every channel. To each channel of the second drive circuit 7E, N white LEDs 82 belonging to the second group are connected.

In the present embodiment, the drive circuit control portion 6, in accordance with the ambient temperature of the LED backlight portion 8A detected by the temperature sensor 9, controls the first drive circuit 7D and the second drive circuit 7E. Specific control is as follows.

The drive circuit control portion 6 determines whether the ambient temperature of the LED backlight portion 8A detected by the temperature sensor 9 is equal to or over a predetermined temperature.

If the ambient temperature of the LED backlight portion 8A detected by the temperature sensor 9 is not equal to nor over the predetermined temperature, the drive circuit control portion 6 equalizes a total output current from the first drive circuit 7D and a total output current from the second drive circuit 7E to each other.

On the other hand, if the ambient temperature of the LED backlight portion 8A detected by the temperature sensor 9 is equal to or over the predetermined temperature, the drive circuit control portion 6 lowers one of the total output current from the first drive circuit 7D and the total output current from the second drive circuit 7E than the other. Here, a structure (e.g., a structure which for every time the ambient temperature of the LED backlight portion 8A is equal to or over the predetermined temperature, changes the control which lowers the total output current from the first drive circuit 7D than the total output current from the second drive circuit 7E and the control which lowers the total output current from the second drive circuit 7E than the total output current from the first drive circuit 7D for each other) is desirable, in which it is possible to avoid an excessive difference between the life expiration time of the white LED 81 belonging to the first group and the life expiration time of the white LED 82 belonging to the second group.

According to the above control, when the ambient temperature of the LED backlight portion 8A is equal to or over the predetermined temperature, one of the white LED 81 belonging to the first group and the white LED 82 belonging to the second group is turned on at a brightness lower than the other, so that it is possible to reduce the heat generation amount from the LED backlight portion 8A. The LED has a characteristic that if the LED operates at a higher temperature, the life becomes shorter, so that according to the above control, it is possible to achieve a long life of the LED backlight portion 8A.

Here, in the present embodiment as well, like the first embodiment, it is possible to replace the LED backlight portion 8A with the LED backlight portion 8B (see FIG. 3) that is a direct type of backlight unit or the LED backlight portion 8C (see FIG. 4A) that is an edge type of backlight unit.

### Fourth Embodiment

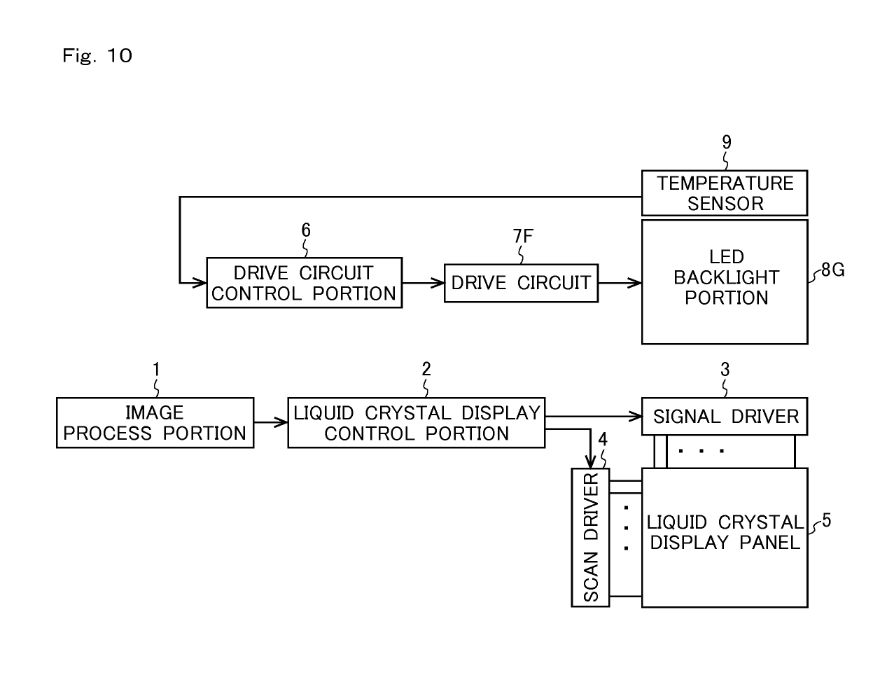

FIG. 10 shows a schematic structure of a display apparatus according to a fourth embodiment of the present invention. Here, in FIG. 10, the same portions as FIG. 1 are indicated by the same reference numbers and detailed description is slipped. The display apparatus shown in FIG. 10 according to the fourth embodiment of the present invention has a structure in which the first drive circuit 7A, the second drive circuit 7B and the LED backlight portion 8A are removed from the display apparatus shown in FIG. 1 according to the first embodiment of the present invention; instead of them, a first drive circuit 7F and an LED backlight portion 8G are disposed. Here, in the present embodiment, the drive circuit control portion 6 and the drive circuit 7F correspond to the backlight control portion described in claims.

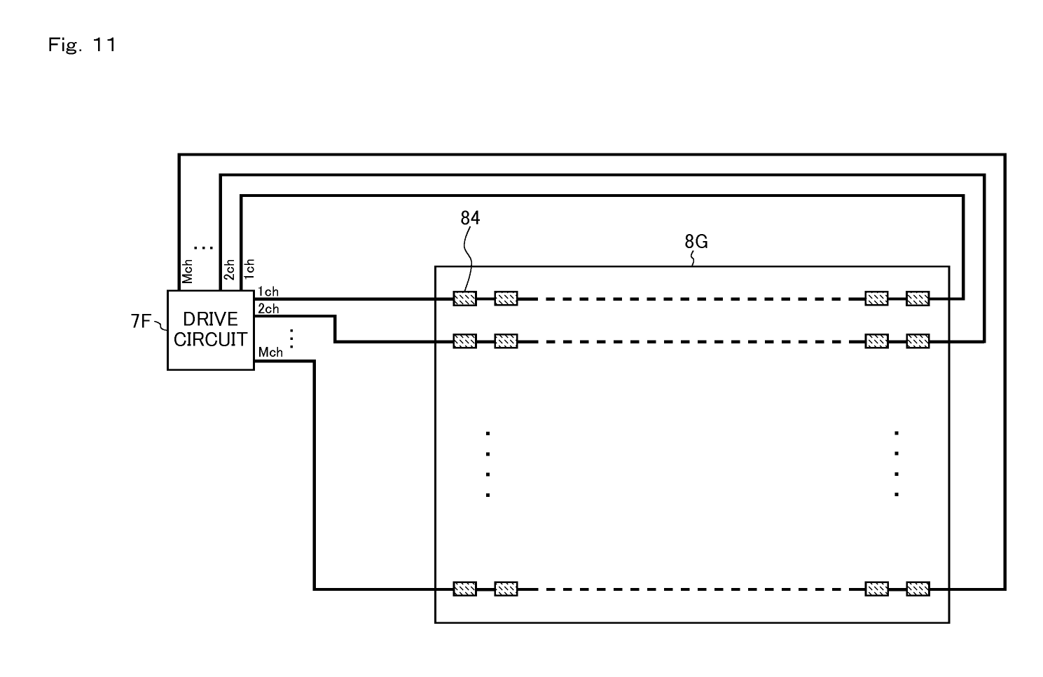

The LED backlight portion 8G is a direct type of backlight unit in which white LEDs 84 are connected in series as shown in FIG. 11. The drive circuit 7F is an M-channel output drive circuit and is able to perform constant-current driving in which an independent constant current value is set for every channel. To each channel of the first drive circuit 7F, N white LEDs 84 are connected. Here, in FIG. 11, part of the wirings that connect the LEDs in the same group to each other are not shown. In the LED backlight portion 8G, the plurality of white LEDs are not divided into groups and all of the plurality of white LEDs are in the same turned-on state, so that a structure of the LED backlight portion 8G does not become complicated.

In the present embodiment, the drive circuit control portion 6, in accordance with the ambient temperature of the LED backlight portion 8G detected by the temperature sensor 9, controls the drive circuit 7F. Specific control is as follows.

The drive circuit control portion 6 determines whether the ambient temperature of the LED backlight portion 8G detected by the temperature sensor 9 is equal to or over a predetermined temperature.

If the ambient temperature of the LED backlight portion 8G detected by the temperature sensor 9 is not equal to nor over the predetermined temperature, the drive circuit control portion 6 increases a total out put current from the first drive circuit 7F than in a time of the same image display in a case of the predetermined temperature or higher.

If the ambient temperature of the LED backlight portion 8G detected by the temperature sensor 9 is equal to or over the predetermined temperature, the drive circuit control portion 6 lowers the total out put current from the first drive circuit 7F than in a time of the same image display in a case of smaller than the predetermined temperature.

According to the above control, when the ambient temperature of the LED backlight portion 8G is equal to or over the predetermined temperature, it is possible to decrease an electric current that flows in the white LED 84 and reduce a heat generation amount from the LED backlight portion 8G. The LED has a characteristic that if the LED operates at a higher temperature, the life becomes shorter, so that according to the above control, it is possible to achieve a long life of the LED backlight portion 8G.

### Fifth Embodiment

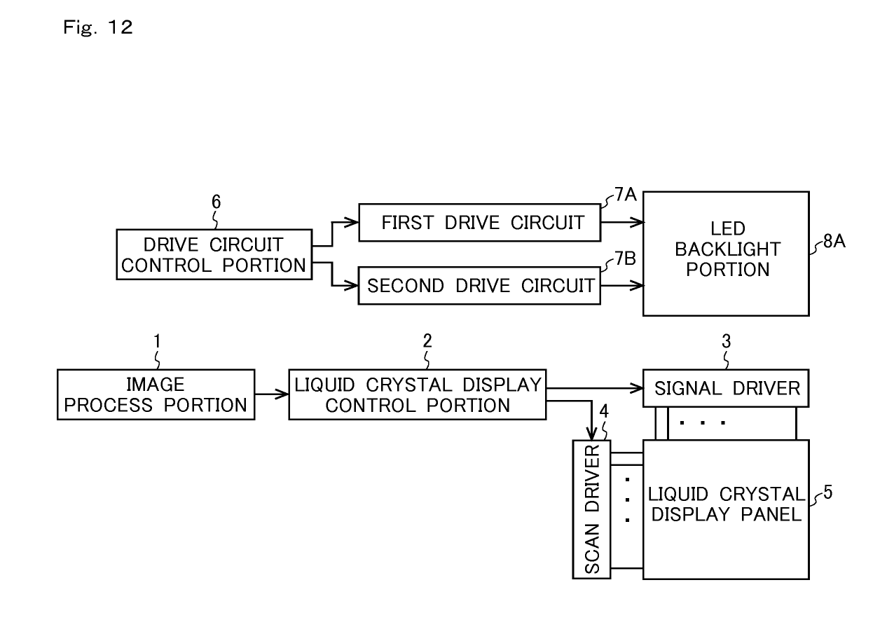

FIG. 12 shows a schematic structure of a display apparatus according to a fifth embodiment of the present invention. Here, in FIG. 12, the same portions as FIG. 1 are indicated by the same reference numbers and detailed description is slipped. The display apparatus shown in FIG. 12 according to the fifth embodiment of the present invention has a structure in which the temperature sensor 9 is removed from the display apparatus shown in FIG. 1 according to the first embodiment of the present invention. Here, in the present embodiment, the drive circuit control portion 6, the first drive circuit 7A and the second drive circuit 7B correspond to the backlight control portion described in claims.

In the present embodiment, the drive circuit control portion 6 operates the first drive circuit 7A and the second drive circuit 7B alternately at a predetermined period. The predetermined period is set in a range in which the changeover between the turning-on of the white LED 81 belonging to the first group and the turning-on of the white LED 82 belonging to the second group is not recognized as a flicker; and it is possible to curb a temperature increase of the white LED 81 belonging to the first group and of the white LED 82 belonging to the second group compared with a case where all of the white LED 81 belonging to the first group and the white LED 82 belonging to the second group are turned on.

According to the above control, it is possible to reduce the heat generation amount from the LED backlight portion 8A. The LED has a characteristic that if the LED operates at a higher temperature, the life becomes shorter, so that according to the above control, it is possible to achieve a long life of the LED backlight portion 8A.

Here, in the present embodiment as well, like the first embodiment, it is possible to replace the LED backlight portion 8A with the LED backlight portion 8B (see FIG. 3) that is a direct type of backlight unit or the LED backlight portion 8C (see FIG. 4A) that is an edge type of backlight unit.

### Sixth Embodiment

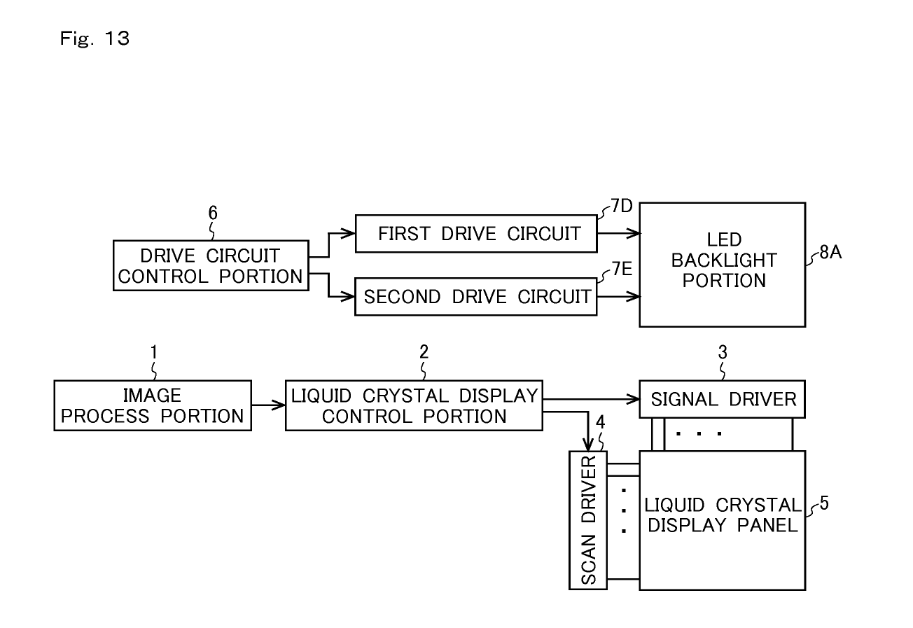

FIG. 13 shows a schematic structure of a display apparatus according to a sixth embodiment of the present invention. Here, in FIG. 13, the same portions as FIG. 9 are indicated by the same reference numbers and detailed description is slipped. The display apparatus shown in FIG. 13 according to the sixth embodiment of the present invention has a structure in which the temperature sensor 9 is removed from the display apparatus shown in FIG. 9 according to the third embodiment of the present invention. Here, in the present embodiment, the drive circuit control portion 6, the first drive circuit 7D and the second drive circuit 7E correspond to the backlight control portion described in claims.

In the present embodiment, the drive circuit control portion 6 lowers one of the total output current from the first drive circuit 7D and the total output current from the second drive circuit 7E than the other. Here, a structure (e.g., a structure which for every time a power supply of the display apparatus is turned on, changes the control which lowers the total output current from the first drive circuit 7D than the total output current from the second drive circuit 7E and the control which lowers the total output current from the second drive circuit 7E than the total output current from the first drive circuit 7D for each other) is desirable, in which it is possible to avoid an excessive difference between the life expiration time of the white LED 81 belonging to the first group and the life expiration time of the white LED 82 belonging to the second group.

According to the above control, it is possible to reduce the heat generation amount from the LED backlight portion 8A. The LED has a characteristic that if the LED operates at a higher temperature, the life becomes shorter, so that according to the above control, it is possible to achieve a long life of the LED backlight portion 8A.

Here, in the present embodiment as well, like the first embodiment, it is possible to replace the LED backlight portion 8A with the LED backlight portion 8B (see FIG. 3) that is a direct type of backlight unit or the LED backlight portion 8C (see FIG. 4A) that is an edge type of backlight unit.

### Seventh Embodiment

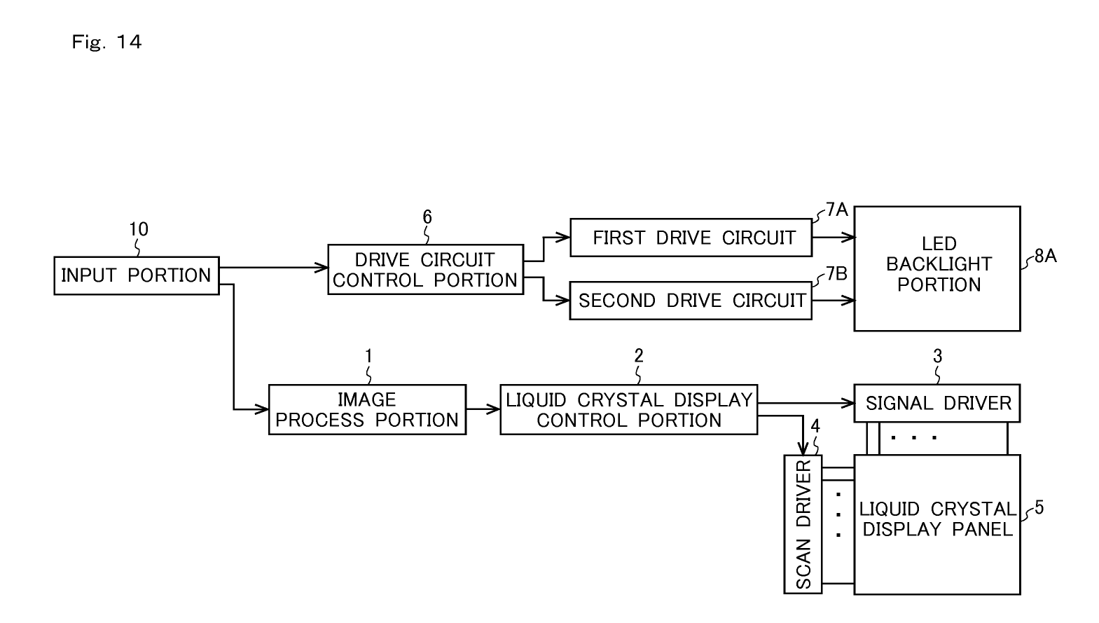

FIG. 14 shows a schematic structure of a display apparatus according to a seventh embodiment of the present invention. Here, in FIG. 14, the same portions as FIG. 1 are indicated by the same reference numbers and detailed description is slipped. The display apparatus shown in FIG. 14 according to the seventh embodiment of the present invention has a structure in which the temperature sensor 9 is removed from the display apparatus shown in FIG. 1 according to the first embodiment of the present invention; and an input portion 10 is added. Here, in the present embodiment, the drive circuit control portion 6, the first drive circuit 7A and the second drive circuit 7B correspond to the backlight control portion described in claims.

The input portion 10, based on an output signal from a key (not shown) disposed on a display-apparatus main body or on infrared data transmitted from a remote control transmitter, generates input information in accordance with a user's operation; and based on the input information, controls the image process portion 1 and the drive circuit control portion 6.

When the user performs an operation that corresponds to a call for a menu screen, the image process portion 1, in accordance with the control by the input portion 10, generates OSD (On Screen Display) data for the menu screen and outputs the data the liquid crystal display control portion 2. In this way, the liquid crystal display panel 5 displays the menu screen.

When the user performs an operation that corresponds to selection of an all LED turning-on mode in a state in which the liquid crystal display penal 5 displays the menu screen, the drive circuit control portion 6, in accordance with the control by the input portion 10, operates both of the first drive circuit 7A and the second drive circuit 7B. In this way, both of the white LED 81 belonging to the first group and the white LED 82 belonging to the second group are turned on.

On the other hand, when the user performs an operation that corresponds to selection of an LED long life mode in the state in which the liquid crystal display penal 5 displays the menu screen, the drive circuit control portion 6, in accordance with the control by the input portion 10, operates only either of the first drive circuit 7A and the second drive circuit 7B. In this way, only either of the white LED 81 belonging to the first group and the white LED 82 belonging to the second group is turned on.

Here, in the LED long life mode, a structure may be employed, in which at first the drive circuit control portion 6 operates the first drive circuit 7A only and when at least one of the white LEDs 81 belonging to the first group comes to the life end, the second drive circuit 7B only is operated; or a structure (e.g., a structure in which every time the power supply of the display apparatus is turned on, the group to be turned on is changed) may be employed, in which it is possible to avoid an excessive difference between the life expiration time of the white LED 81 belonging to the first group and the life expiration time of the white LED 82 belonging to the second group; however, from the viewpoint for securing all possible turning-on times of the white LED 81 belonging to the first group and the white LED 82 belonging to the second group as long as possible, the latter structure is more desirable. Besides, in the former structure, it is necessary to determine whether at least one of the white LEDs 81 belonging to the first group comes to the life end or not; as the determination method, for example, a method may be employed, in which a portion for storing an accumulated turned-on time, that is, operation time of the white LEDs 81 belonging to the first group is disposed; when the accumulated turned-on time of the white LEDs 81 belonging to the first group exceeds a predetermined life, it is determined that at least one of the white LEDs 81 belonging to the first group comes to the life end; or a method may be employed, in which a portion for detecting a voltage across both terminals of a series circuit of the white LED 81 belonging to the first group and detecting an electric current that flows in the white LED 81 belonging to the first group is disposed; when at least one of the across-the-terminals voltage and the electric current exceeds a predetermined normal range, it is determined that at least one of the white LEDs 81 belonging to the first group comes to the life end.

According to the above control, when the LED long life mode is selected, it is possible to decrease the number of turned-on LEDs and reduce the heat generation amount from the LED backlight portion 8A. The LED has a characteristic that if the LED operates at a higher temperature, the life becomes shorter, so that according to the above control, it is possible to achieve a long life of the LED backlight portion 8A.

Here, in the present embodiment as well, like the first embodiment, it is possible to replace the LED backlight portion 8A with the LED backlight portion 8B (see FIG. 3) that is a direct type of backlight unit or the LED backlight portion 8C (see FIG. 4A) that is an edge type of backlight unit.

<Others>

The embodiments according to the present invention are described above; however, the present invention is not limited to these embodiments: it is possible to add various alterations and put them into practice without departing from the spirit of the present invention. Several exemplary alterations are described below.

In the above first to third embodiments and the fifth to seventh embodiments, the LEDs belonging to the same group are periodically disposed every two devices, every two lines, every three devices or every three lines; however, the present invention is not limited to these: for example, other dispositions may be employed, in which the LEDs are divided into four groups; and the LEDs belonging to the same group are disposed every four devices or every four lines or the like.

Besides, in the above fifth to seventh embodiments, it is possible to employ variations in which the LEDs are divided not into the two groups but into three or more groups. In these variations, in the above fifth embodiment, a structure may be employed, in which the LEDs belonging to the respective groups are successively turned on; in the above sixth embodiment, a structure may be employed, in which the LEDs belonging to part of the groups are turned on at a brightness in accordance with the second constant current, and the LEDs belonging to the rest of the groups are turned on at a brightness in accordance with the first constant current; in the above seventh embodiment, a structure may be employed, in which the LEDs belonging to a group are turned on in the LED long life mode.

Besides, for example, in the above seventh embodiment, the all LED turning-on mode may be discarded. In this case, only the LED long life mode is performed, so that it becomes unnecessary to select the LED long life mode.

Besides, it is possible to arbitrarily combine the contents of the above embodiments and the above alterations and put the combinations in practice as long as there is no discrepancy.

For example, it is possible to combine the above first embodiment and third embodiment. In this case, if the ambient temperature of the LED backlight portion 8A is not equal to nor over a first temperature, the drive circuit control portion 6 operates both of the first drive circuit 7D and the second drive circuit 7E such that the total output current from the first drive circuit 7D and the total output current from the second drive circuit 7E become equal to each other; if the ambient temperature of the LED backlight portion 8A is equal to or over the first temperature and under a predetermined second temperature that is higher than the first temperature, the drive circuit control portion 6 operates only either of the first drive circuit 7D and the second drive circuit 7E such that the total output current becomes equal to the total output current in the time of the same image display in the case of smaller than the first temperature; if the ambient temperature of the LED backlight portion 8A is equal to or over the second temperature, the drive circuit control portion 6 operates only either of the first drive circuit 7D and the second drive circuit 7E such that the total output current becomes smaller than the total output current in the time of the same image display in the case of smaller than the first temperature.

Besides, for example, it is possible to combine the above first embodiment and sixth embodiment. In this case, if the ambient temperature of the LED backlight portion 8A is not equal to nor over the predetermined temperature, the drive circuit control portion 6 lowers one of the total output current from the first drive circuit 7D and the total output current from the second drive circuit 7E than the other; if the ambient temperature of the LED backlight portion 8A is equal to or over the predetermined temperature, the drive circuit control portion 6 operates only either of the first drive circuit 7D and the second drive circuit 7E such that the total output current becomes equal to the total output current in the time of the same image display in the case of smaller than a predetermined temperature, without operating the other.

What is claimed is:

1. A display apparatus comprising:
a display panel;
a backlight portion that shines light onto the display panel from a rear surface of the display panel;
a backlight control portion that controls the backlight portion;
wherein the backlight portion includes a plurality of LEDs and the plurality of LEDs are divided into a plurality of fixed groups;
wherein the backlight control portion is capable of performing at least either of: first control which turns off the LEDs that belong to one group and turns on the LEDs that belong to a group other than the one group and second control which turns on the LEDs that belong to the one group at a brightness lower than a brightness for turning on the LEDs that belong to the group other than the one group.

2. The display apparatus according to claim 1, wherein the LEDs that belong to each of the groups are periodically disposed in each of the groups.

3. The display apparatus according to claim 1, further comprising a temperature sensor that detects an ambient temperature of the backlight portion;
wherein if the ambient temperature detected by the temperature sensor exceeds a predetermined temperature, the backlight control portion performs the first control.

4. The display apparatus according to claim 1, wherein the backlight control portion performs the first control replacing the one group and the group other than the one group with each other at a predetermined period.

5. The display apparatus according to claim 1, the backlight control portion performs the first control; and if at least one of the LEDs that belong to the one group comes to a life end, replaces the one group with the group other than the one group.

6. The display apparatus according to claim 2, further comprising a temperature sensor that detects an ambient temperature of the backlight portion;
wherein if the ambient temperature detected by the temperature sensor exceeds a predetermined temperature, the backlight control portion performs the first control.

7. The display apparatus according to claim 2, wherein the backlight control portion performs the first control replacing the one group and the group other than the one group with each other at a predetermined period.

8. The display apparatus according to claim 2, the backlight control portion performs the first control; and if at least one of the LEDs that belong to the one group comes to a life end, replaces the one group with the group other than the one group.

9. A display apparatus comprising:
a display panel;
a backlight portion that shines light onto the display panel from a rear surface of the display panel;
a backlight control portion that controls the backlight portion; and
a temperature sensor that detects an ambient temperature of the backlight portion;
wherein the backlight portion is a backlight unit that includes a plurality of LEDs;
wherein the backlight control portion, if the ambient temperature of the backlight portion detected by the temperature sensor exceeds a predetermined temperature, performs control which turns on all of the plurality of LEDs at a brightness lower than a brightness at a time the ambient temperature of the backlight portion detected by the temperature sensor is equal to or lower than the predetermined temperature.
